(19) United States
(12) Patent Application Publication
(10) Pub. No.: US 2003/0028591 A1
(43) Pub. Date: Feb. 6, 2003

(54) Browser having dynamically self-adjusting rendering functionality

(76) Inventors: Alexey Goloshubin, Bergen (NO); Jeremy Cook, Nesttun (NO); Stephen Maryka, Calgary (CA)

Correspondence Address: Davidson, Davidson & Kappel, LLC, 14th Floor, 485 Seventh Avenue, New York, NY, 10018, US

(21) Appl. No.: 10/198,547

(22) Filed: Jul. 18, 2002

Related U.S. Application Data
(60) Provisional application No. 60/306,598, filed on Jul. 19, 2001.

(51) Int. Cl. G06F 15/16; G06F 15/177

(52) U.S. Cl. 709/203; 709/221

(57) ABSTRACT

A method for dynamically self-adjusting rendering functionality in a browser includes providing a stimulus to the browser, and reacting to the stimulus using the browser so as to direct a change in a rendering module inventory associated with the browser. The stimulus may include a user interaction, a memory threshold trigger, a freshness logic trigger, a change in IP address and/or a change in a browser connection type. The change in the rendering module inventory may be downloading a rendering module and/or removal of a rendering module. A rendering module may be downloaded from a remote server over the Internet.

This application claims priority from U.S. Provisional Application Ser. No. 60/306,598, filed Jul. 19, 2001, the entire disclosure of which is hereby incorporated by reference.

### BACKGROUND INFORMATION

A web browser, hereinafter referred to simply as a browser, is a software application capable of locating and displaying pages on the World Wide Web (“the web”). A browser is therefore typically capable of reading Hypertext Markup Language (HTML) and of communicating with web pages using Hypertext Transfer Protocol (HTTP), File Transfer Protocol (FTP), and other protocols used to transfer information over the Internet.

Web pages may contain various types of content, e.g., data written in various different formats, and programs written in various different languages. For example, in addition to HTML documents, a web page may contain Javascript files, music files, video files, etc. In order to fully process a web page, a browser must include functionality to process the content. Processing the content may including displaying a result, such as text, a graphical image, or a video clip, or playing a music file, for example. Such processing of specific content types may in general be referred to as rendering.

The Ice Storm browser sold by Wind River contains a core, which provides the basic browser functionality, a plurality of scripters and a plurality of rendering modules (referred to commercially as Pilots). The rendering modules include the functionality which allows content to be rendered on the browser. Examples of rendering modules include, for example, HTML rendering modules, Applet rendering modules, and JMF rendering modules. A scripting module, or scripter, provides the glue between various renderers and the framework. The scripter knows how to execute commands in the scripting language it supports, and also allows pilots to expose their methods into the scripting environment without dependency on a particular scripter. The core includes a rendering module interface and a scripter interface for interacting with the rendering modules and scripters. The Ice Storm architecture can support additional rendering modules and scripters which may be developed by Wind River or third parties in the future.

Traditional browsers such as Netscape Communicator (NC) and Microsoft Internet Explorer (MSIE) handle content through a series of so-called plug-ins. These are dynamically loadable pieces of native code (i.e. code for a specific operating system) that are loaded into the browser from the local file system at run time. Content can also be handled through external helper applications such as Acrobat Reader, or a PostScript viewer.

A plug-in or rendering module that has been loaded typically remains in the browser, whether or not it is used at all or ever needed again. A plug-in thus remains loaded in the browser, occupying memory space unless the user takes affirmative action to remove it.

### SUMMARY

In accordance with a first embodiment of the present invention, a method for dynamically adjusting rendering functionality in a browser is provided which includes providing a stimulus to the browser and reacting to the stimulus using the browser so as to direct a change in a rendering module inventory associated with the browser.

In accordance with a second embodiment of the present invention, a browser having dynamically adjusting rendering functionality is provided which includes a logic unit for reacting to a stimulus so as to direct a change in a rendering module inventory associated with the browser; and a core for interacting with the rendering module inventory so as to render a content.

In accordance with a third embodiment of the present invention, a system for dynamically adjusting rendering functionality in a browser is provided which includes a host computer, the browser residing on the host computer, a first server capable of locating and downloading a rendering module to the browser in response to a request from the browser, and a communication path connecting the host computer and the server.

In accordance with a fourth embodiment of the present invention, a method for managing a licensing of a plurality of rendering modules is provided, wherein the rendering modules each provide a respective functionality to a browser of a user. The method includes storing the plurality of rendering modules on a server, downloading to the browser a first of the plurality of rendering modules in response to a request from the browser, the downloaded first rendering module being usable by the browser to render a content, and determining a licensing fee for the user based on the downloading of the first rendering module or an authorization to download the first rendering module.

### BRIEF DESCRIPTION OF THE DRAWINGS

FIG. 1 shows a flow chart of a method for dynamically adjusting rendering functionality of a browser.

FIG. 2 shows a schematic block diagram of a browser having dynamically adjusting rendering functionality demonstrating the functioning of the browser.

FIG. 3 shows a flow chart of a browser reacting to a stimulus so as to direct a change in a rendering module inventory of the browser.

FIG. 4 shows a schematic block diagram of a system for dynamically adjusting rendering functionality in a browser.

### DETAILED DESCRIPTION

As described above, the present invention provides a method for dynamically adjusting the rendering functionality in a browser. This can be desirable in applications where memory space is at a premium. The method in accordance with certain embodiments of the invention includes providing a stimulus to the browser; and reacting to the stimulus using the browser so as to direct a change in a rendering module inventory associated with the browser.

The stimulus may, for example, include a user interaction, a memory threshold trigger, a freshness logic trigger, a change in Internet Protocol (IP) address and/or a change in a browser connection type. In certain embodiments, stimulus may include browsing to a new type of content, for example, via user interaction or automated direction from a web server. In such embodiments, the method according to the present invention may include determining at least one or more rendering modules needed to download and/or display the new type of content.

Moreover, the stimulus may be provided in response to an assessing of an availability of a computational resource, such as a memory, of a computer running the browser. In this regard, a logic unit of the browser may be used to assess the availability of the computational resource of the computer running the browser.

The change in the rendering module inventory may include a downloading of a first rendering module and/or a removal of a second rendering module. A downloading of a rendering module may be performed over a local area network (LAN), a dedicated communications link, a telephone line, a satellite link and/or the Internet.

In reacting to the stimulus so as to direct the change in browser inventory, the browser may use a browsing history of the browser or a user of the browser. For example, the browser might discard infrequently used browser inventory in response to a stimulus which indicated that memory resources were unacceptably low.

A downloading of a rendering module may be performed using a first server. An Internet address of the first server may be stored in a memory associated with the browser. The first server may locate and access the rendering module to be downloaded. Moreover, the first server may identify the rendering module to be downloaded based on a content to be rendered by the browser.

The rendering module itself may be located on the first server or on a second server accessible to the first server via the Internet. In this regard, an Internet address of the second server (or the address of the rendering module on the second server) could be stored in a memory of the first server.

The change in the rendering module inventory may include removing a rendering module using a cache architecture-type decision logic. The cache architecture-type decision logic may, for example, include a least recently used logic.

The present invention also provides a browser having dynamically adjusting rendering functionality, the browser including a logic unit for reacting to a stimulus so as to direct a change in a rendering module inventory associated with the browser, and a core for interacting with the rendering module inventory so as to render a content.

The present invention also provides a computer readable medium having stored thereon computer executable process steps operative to perform a method for dynamically adjusting rendering functionality in a browser, the method including providing a-stimulus to the browser, and reacting to the stimulus using the browser so as to direct a change in a rendering module inventory associated with the browser.

The present invention also provides a system for dynamically adjusting rendering functionality in a browser, the system including: a host computer, the browser residing on the host computer; a first server capable of locating and/or downloading a rendering module to the browser in response to a request from the browser; and a communication path connecting the host computer and the server. In certain embodiments, the first server may locate the rendering module (which itself may be on the first server or on another server) and download it to the browser. In other embodiments, the first server may simply locate the rendering module (which may be on a second server) and provide the browser with the IP address of the rendering module. In any event, the request from the browser may be provided in response to a stimulus to the browser, the stimulus to the browser including at least one of a user interaction, a change in web address, and a change in a browser connection type.

The present invention also provides a method for managing a licensing of a plurality of rendering modules, the rendering modules each providing a respective functionality to a browser of a user, the method including: storing the plurality of rendering modules on a server; downloading to the browser a first of the plurality of rendering modules in response to a request from the browser, the downloaded first rendering module being usable by the browser to render a content; and determining a licensing fee for the user based on the downloaded first rendering module. This method may further include providing a stimulus to the browser, the request from the browser being provided in response to the stimulus, the stimulus including at least one of a user interaction, a change in web address, and a change in a browser connection type.

The present invention provides a browser capable of dynamically and transparently adjusting its content rendering capabilities adding and removing rendering modules in an intelligent manner. Efficiency of memory space usage may thereby be increased.

Although the embodiments described above have broad applicability for web browsers in general, they are particularly advantageous in the field of embedded computing, where computational resources, such as memory space, storage space, and processing time, are often severely limited.

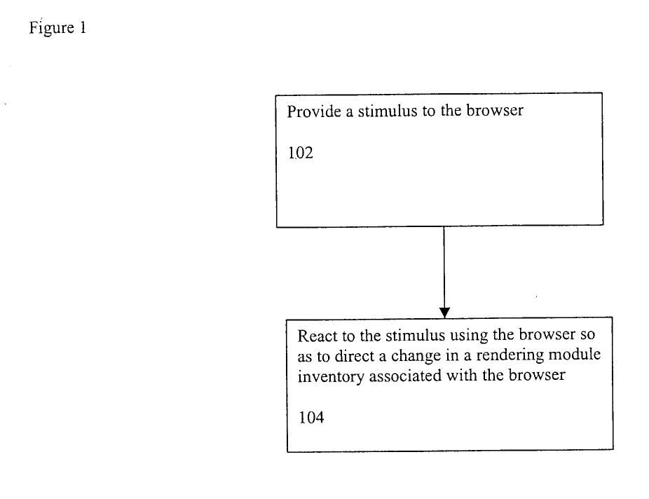

FIG. 1 shows a flow chart of an illustrative method in accordance with the present invention for dynamically adjusting rendering functionality of a browser. First, a stimulus is provided to the browser (Step 102). The stimulus is then reacted to using the browser so as to direct a change in a rendering module inventory associated with the browser (Step 104). The rendering module inventory associated with the browser may be the renderers, or rendering modules, currently loaded in the browser or currently co-resident on a device or computer on which the browser is running.

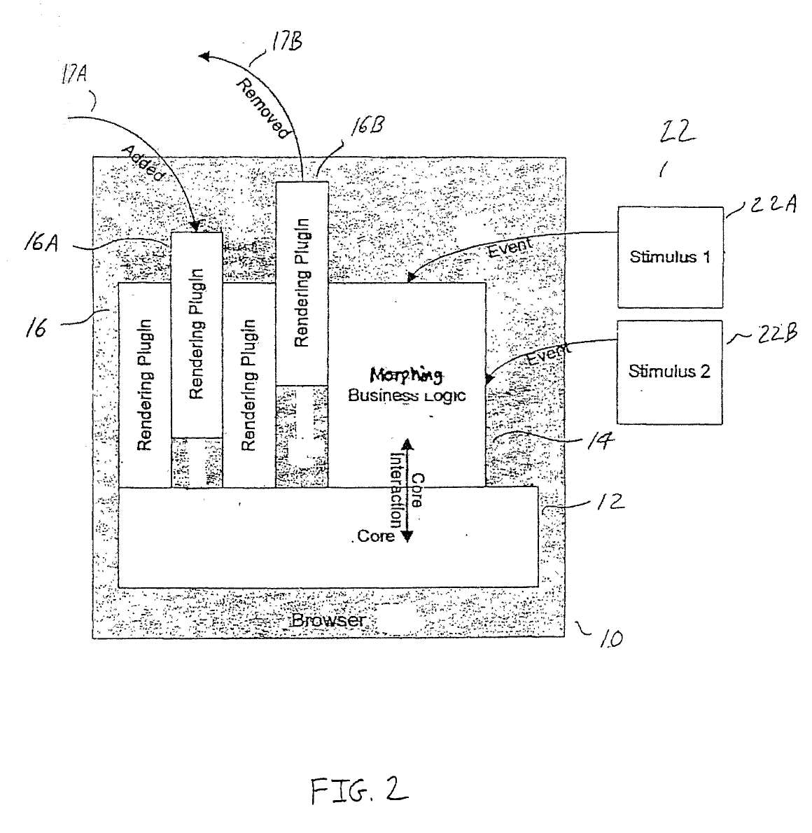

FIG. 2 shows a schematic bock diagram of a browser 10 having dynamically adjusting rendering functionality, the diagram demonstrating the functioning of the browser. Browser 10, loaded and running on computing device 9, includes core 12, rendering module inventory 16 including one or more rendering plugins, or modules 16A, 16B, etc., and morphing business logic unit 14.

Browser 10 is a software component or application which may be written, for example, in Java or other appropriate programming language. Browser 10 may be integrated into another Java application. Computing device 9, on which browser 10 is loaded and runs, may be an Internet appliance, such as a Web pad or Internet screen phone, digital set-top box, desktop computer, laptop computer, embedded computer or any other device which can access the Internet. Browser 10 may act as a standalone Java application embedded in a device, or be incorporated as a “browser in a window” of the embedded application. Browser 10 may be used for HTML-based help systems in enterprise Java applications. Browser 10 preferably has a modular architecture.

Core 12 forms the kernel of the browser, providing basic functionality and the capability to locating and display pages on the World Wide Web (“the web”). A such, core 12 includes an HTTP processor. Core may also have integrated HTML rendering functionality. In some embodiments of the present invention, HTML capability may be provided by an HTML rendering module separate from core 12, for example as one of rendering plugins 16. The Ice Storm browser sold by Wind River Systems is an example of such an architecture.

Rendering plugins 16 may be similar to prior art rendering modules (such as those sold as the Ice Storm browser) each providing rendering, or processing, of a respective type of content. Rendering plugins 16 may be pilots, i.e., compact, platform-independent and dynamically-loadable rendering modules. As pilots, rendering plugins 16 may have a higher level of integration with the browser core and thus provide enhanced content-rendering support. Since the pilot can be configured to communicate directly to the core without the need for an interpreter, the pilot can provide for a higher level of integration than prior art rendering modules. Also, unlike prior art rendering modules, the pilots can be dynamically loaded and unloaded in response to specific stimuli. Thus, memory usage can be improved. For example, specific rendering functions implemented as pilots can be dynamically loaded into the browser to display data downloaded from a particular web-site. Then, when the browser leaves the web-site, the pilots can be dynamically unloaded from the pilot.

Morphing business logic 14 is a logic unit that is capable of reacting to specific stimuli 22 so as to direct a change in the rendering modules 16 associated with the browser. For example, FIG. 2 depicts stimuli 22A and 22B resulting, respectively, in the addition 17A of a rendering module removal 17B of a rendering module. Morphing business logic 14 can be, for example, a set of logical rules that specify a response to a particular stimuli. The morphing business logic 14 can be implemented as a module that accesses a table when a specified stimulus is received. The table can include the types of stimuli and the corresponding set of logical rules. The morphing business logic 14 module can then cross reference the particular stimuli to find the appropriate set of logical rules to apply to the stimuli. In certain embodiments of the present invention, the user and/or executing process (e.g., on the browser) can dynamically modify the table, so that types of stimuli and the sets of logical rules for the stimuli can be changed, added, or deleted. Morphing business logic 14 may be customized for a specific class of devices and a variety of stimuli.

Stimuli 22 may be asynchronous events that warrant an adjustment in the rendering functionality of the browser. Such events include a user interaction, a memory threshold trigger, a freshness logic trigger, a change in web or IP address, and a change in a browser connection type. Stimuli 22 may be generated outside browser 10 or within the browser itself, for example, within morphing business logic 10 using corresponding algorithms or routines.

User interactions that may warrant an adjustment in rendering functionality of browser 10 include the user of the browser browsing to a new type of content which is not supported by the current rendering module inventory. For example, the user browses to an HTML web page in which Javascript code and a video clip are embedded, but no Javascript rendering module and no multimedia rendering module are present in the browser. Another user interaction which may warrant an adjustment in rendering functionality of the browser is the user changing the browser communication connection to a connection with a different bandwidth. Such a change in throughput capability could, for example, enable a different content to be supported. For example, a higher speed connection could enable high bandwidth video to be supported, which in turn may require an appropriate rendering module to permit viewing the video.

A memory threshold trigger may occur when an amount of memory available to browser 10 changes. For example, other applications running on device on which the browser is running may reduce the amount of memory available to the browser, causing the onset of a memory threshold condition, or a memory threshold trigger. In certain embodiments, other applications running on device on which the browser is running may reduce the amount of processor time available to the browser, causing the onset of a computation threshold condition, or a computation threshold trigger.

A freshness logic trigger is an output of an algorithm which monitors the presence and access history of rendering modules 16 present in browser 10. The amount of time a rendering module has been present in the browser, the number of times a rendering module has been accessed and/or the amount of time since a rendering module has been accessed are examples of the type of monitoring that may be carried out. In response to such a trigger, the system could discard infrequently used modules to increase the available memory on the device implementing the browser.

It should be noted that a change in web or IP address may occur with or without direct user interaction. For example, a browser may access a new web site as a result of the running of an applet embedded in a current web page.

A change in browser connection type includes a change in the communication connection speed available to browser 10. Moreover, the change in browser connection type may include a change in the protocol used for communication (e.g., TCP/IP to UDP), or a change in the specifications of the protocol currently in use (e.g., a datagram size change from 128 to 64 bytes. In dynamic bandwidth allocation environments, the browser connection speed may vary so as to alter the capability to process certain content and concomitantly demand the use of certain rendering modules, as described above with respect to high bandwidth video rendering. In certain embodiments, the morphing business logic 14 can be configured to adjust the protocol or specifications thereof to the current connection. Thus, data throughput can be maximized.

Morphing business logic 14 may identify a rendering module for removal from rendering module inventory 16, for example to make room in a memory for downloading an additional rendering module. A decision methodology or algorithm may be employed to identify which of the rendering modules is to be removed. Removal decisions may be based upon a browsing history of the browser user. A cache architecture-type decision methodology, for example a least recently used algorithm, may be used to identify a rendering module that is a candidate for removal, as well as when that rendering module is to be removed. In some embodiments according to the present invention, a rendering module could be discarded immediately after it has been used, thus quickly freeing up memory space. A decision methodology described above, or other decision methodology, may be implemented.

Morphing business logic 14 may employ a variety of criteria for evaluating and responding to a particular stimulus. For example, a rendering module may be required to display new content the user browses to. Morphing business logic 14 may consider the bandwidth of the communication connection available to the browser in assessing which rendering module to have downloaded, or whether to download any rendering module at all, for proper rendering of the new content.

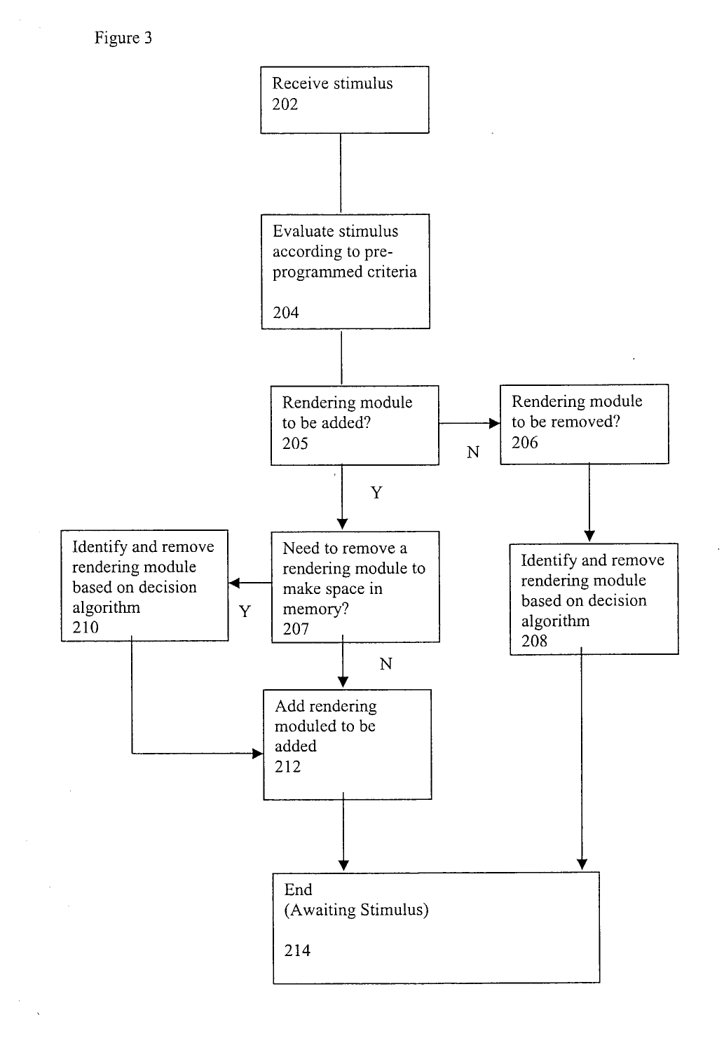

FIG. 3 shows a flow chart of a browser reacting to a stimulus so as to direct a change in a rendering module inventory of the browser. A stimulus is received by the browser, preferably by morphing business logic 14 (Step 202). The stimulus is evaluated according to preprogrammed criteria (Step 204). For example, a memory threshold trigger may be evaluated as requiring the removal of a rendering module from the browser or a new type of content to be rendered may be evaluated as requiring a new rendering module to be loaded. The browser thus determines whether a rendering module is to be added (Step 205). If no rendering module is to be added, then the browser determines whether rendering module needs to be removed (Step 206). If no rendering module needs to be removed, then the stimulus response routine ends (Step 214). If a rendering module does need to be removed, then a rendering module is identified for removal and removed based on a decision algorithm (Step 208) and the routine ends (Step 114). If a rendering module is to be added, then the browser first determines whether a rendering module is to be removed, for example to make space in memory for the rendering module to be added (Step 207). If a rendering is to be removed, then a rendering module is identified for removal and removed based on a decision algorithm (Step 210). If no rendering module is to be removed, or once the rendering module has been identified for removal and removed in Step 210, then a rendering module to be added is identified and added (Step 212). The routine then ends, and the system awaits the next stimulus (Step 214).

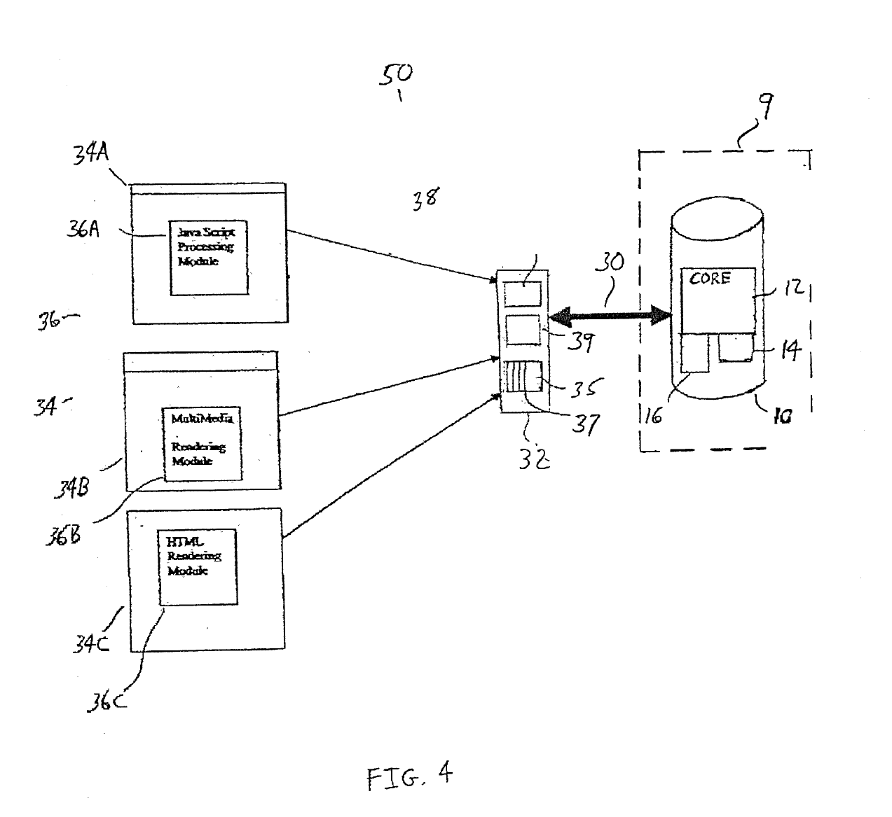

FIG. 4 shows a schematic block diagram of a system 50 for dynamically adjusting the rendering functionality of browser 10. System 50 includes browser 10, module manager 32 and a plurality of rendering modules 36 each stored on a respective server 34. Browser 10 includes core 12, morphing business logic 14 and rendering module inventory 16.

As discussed above, browser 10 maybe resident in an embedded device or otherwise loaded on a computing platform (not shown). Module manager 32 is located remotely from browser 10, communication between the module manager and the browser being effected over communication path 30. Communication path 30 may include the Internet, but additionally or alternatively may include a dedicated link, LAN, telephone line, satellite link or other suitable connection, depending on the specific configuration of system 50. Module manager 32 in turn is connectable to servers 34 via respective communication paths 38. Communication paths 38 maybe established over the Internet, but additionally or alternatively may include a dedicated communication link, LAN, telephone line, satellite link or other suitable connection.

Module manager 32 may be a server which stores data base 33 containing location addresses, for example IP addresses, of the respective servers 34 at which rendering modules 36 may be accessed. Module manager 32 may additionally store the specific address within a respective host 34 at which a rendering module 36 resides. Alternatively, browser 10 may itself contain addresses of rendering modules and/or servers 34. Module manager 32 may be capable of determining what rendering module is needed to process or display a given type of content. Module manager 32 may simply provide browser 10 with a pointer to a specific host server 34. Alternatively, module manager 32 may retrieve a required rendering module 36 from a respective host server 34 and download the rendering module to browser 10. In other embodiments of the present invention, module manager 32 may include an internal library 35 of rendering modules available for downloading to browser 10.

Servers 34 may be any computing platform, host, server, etc., which stores a rendering module 36 available for downloading and use to render a specific type of content. Rendering modules 36 may include Javascript processing module 36A, multimedia rendering module 36B and HTML rendering module 36C, as indicated, or other rendering modules for processing or rendering a respective content.

System 50 may function as follows: the user (not shown) of browser 10 browses (or is automatically directed) to a type of content, for example, a document coded in Javascript. Morphing business logic 14 determines that Javascript rendering capability is needed, but is not present in rendering module inventory 16, and accordingly sends a request to module manager 32 over communication path 30, which may include the Internet. In this regard, it is not necessary that the morphing business logic knows of the existence of Javascript or of a corresponding Javascript rendering module. Rather, the Morphing business logic 14 may simply determine that the browser does not have a rendering module suitable for rendering the content, and provide the module manager 32 with information sufficient to identify an appropriate rendering module (such as, for example, the dot extension of the content file). Using data base 33, module manager determines the address of host 34A containing Javascript processing module 36A. Module manager retrieves a copy of module 36A over communication path 38, which may include the internet, and downloads it over communication path 30 to browser 10, specifically into rendering module inventory 16. In other embodiments of the present invention, module manager 32 may use data base 33 to provide morphing business logic 14, or other component of browser 10, with relevant information, for example the EP address, of host 34A at which Javascript processing module 36A resides. Then morphing business logic 14, for example, accesses host 34A and downloads Javascript processing module 36A to rendering module inventory 16. In yet other embodiments of the present invention, where module manager 32 includes library 35 of stored rendering modules 37, module manager 32 may directly download from library 35 a requested stored rendering module 37 to browser 10.

Module manager 32 may form part of a licensing scheme for managing licensing fee data capture for rendering modules 37 stored in library 35. For example, module manager 32 may record a user identification associated with browser 10 each time a rendering module is downloaded from library 35. This information may be sent to a billing processor so as to effect a per-use licensing scheme. Alternatively, module manager 32 may maintain a list 39 of authorized users for each of stored rendering modules 37 in library 35. Each user may be billed a respective licensing fee corresponding to the modules he has access to. The licensing fee may additionally be based on a specified duration of authorization. Other schemes combining features of the above schemes may be envisioned. For example, module manager 32 may base the per-use licensing scheme on the duration of use of a particular module.

The present invention has been described herein with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for dynamically adjusting rendering functionality in a browser, the method comprising:
providing a stimulus to the browser; and
reacting to the stimulus using the browser so as to direct a change in a rendering module inventory associated with the browser.

2. The method as recited in claim 1 wherein the stimulus includes at least one of a user interaction, a memory threshold trigger, a freshness logic trigger, a change in IP address, and a change in a browser connection type.

3. The method as recited in claim 1 wherein the user interaction includes a browsing to a new type of content.

4. The method as recited in claim 1 wherein the stimulus includes downloading a new type of content and further comprising determining at least one or more rendering modules needed for processing the new type of content.

5. The method as recited in claim 4 wherein the processing includes at least one of downloading and displaying the new type of content.

6. The method as recited in claim 1 wherein the providing the stimulus is performed in response to an assessing of an availability of a computational resource of a computer implementing the browser.

7. The method as recited in claim 6 wherein the computational resource includes a memory of the computer.

8. The method as recited in claim 1 wherein the reacting to the stimulus is performed using a logic unit of the browser.

9. The method as recited in claim 1 wherein the reacting to the stimulus is performed using an assessing of an availability of a computational resource of a computer running the browser.

10. The method as recited in claim 9 wherein the computational resource includes a memory of the computer.

11. The method as recited in claim 1 wherein the reacting to the stimulus is performed using a browsing history of a user of the browser.

12. The method as recited in claim 1 wherein the change in the rendering module inventory includes at least one of a downloading of a first rendering module and a removal of a second rendering module.

13. The method as recited in claim 1 wherein the change in the rendering module inventory includes a downloading of a rendering module and wherein the downloading of the rendering module is performed over at least one of a LAN, a dedicated communications link, a telephone line, a satellite link and the Internet.

14. The method as recited in claim 1 wherein the change in the rendering module inventory includes a downloading of a rendering module and wherein the downloading of the rendering module is performed using a first server.

15. The method as recited in claim 14 further comprising storing an IP address of the first server in a memory associated with the browser.

16. The method as recited in claim 14 wherein the first server locates and accesses the rendering module using the Internet.

17. The method as recited in claim 14 wherein prior to the downloading the first server determines the rendering module to be downloaded based on a content to be rendered by the browser.

18. The method as recited in claim 14 wherein the change in the rendering module inventory includes a downloading of a rendering module, the rendering module being stored for downloading on a second server accessible via the Internet.

19. The method as recited in claim 14 wherein the change in the rendering module inventory includes a downloading of a rendering module, the rendering module being stored for downloading on a second server accessible via the Internet, an Internet address of the second server being stored in a memory of the first server.

20. The method as recited in claim 1 wherein the change in the rendering module inventory includes a downloading of a rendering module and further comprising storing an Internet address of a location of the rendering module to be downloaded in a memory associated with the browser.

21. The method as recited in claim 1 wherein the change in the rendering module inventory includes a removing of a rendering module and wherein the removing of the rendering module is performed using a cache architecture-type decision logic.

22. The method as recited in claim 21 wherein the cache architecture-type decision logic includes a least recently used logic.

23. The method as recited in claim 1 wherein the browser includes a logic unit for reacting to the stimulus and a core.

24. The method as recited in claim 1 wherein the browser is an embedded software application.

25. A browser having dynamically adjusting rendering functionality comprising:
a logic unit for reacting to a stimulus so as to direct a change in a rendering module inventory associated with the browser; and
a core for interacting with the rendering module inventory so as to render a content.

26. The browser as recited in claim 25 wherein the stimulus includes at least one of a user interaction, a memory threshold trigger, a freshness logic trigger, a change in IP address, and a change in a browser connection type.

27. The browser as recited in claim 26 wherein the user interaction includes a browsing to a new type of content.

28. The browser as recited in claim 25 wherein the stimulus includes a user browsing to a new type of content and further comprising determining at least one or more rendering modules needed for processing the new type of content.

29. The method as recited in claim 28 wherein the processing includes at least one of downloading and displaying the new type of content.

30. The browser as recited in claim 25 wherein the stimulus is provided in response to an assessing of an availability of a computational resource of a computer running the browser.

31. The browser as recited in claim 30 wherein the computational resource includes a memory of the computer.

32. The browser as recited in claim 25 wherein the reacting to the stimulus is performed using an assessing of an availability of a computational resource of a computer running the browser.

33. The browser as recited in claim 31 wherein the computational resource includes a memory of the computer.

34. The browser as recited in claim 25 wherein the reacting to the stimulus is performed using a browsing history of a user of the browser.

35. The browser as recited in claim 25 wherein the change in the rendering module inventory includes at least one of a downloading of a first rendering module and a removal of a second rendering module.

36. The browser as recited in claim 25 wherein the change in the rendering module inventory includes a downloading of a rendering module and wherein the downloading of the rendering module is performed over at least one of a LAN, a dedicated communications link a telephone line, a satellite link and the Internet.

37. The browser as recited in claim 25 wherein the change in the rendering module inventory includes a downloading of the rendering module and wherein the downloading of the rendering module is performed using a first server.

38. The browser as recited in claim 37 further comprising storing an Internet address of the first server in a memory associated with the browser.

39. The browser as recited in claim 37 wherein the first server locates and accesses the rendering module using the Internet.

40. The browser as recited in claim 37 wherein prior to the downloading the first server determines the rendering module to be downloaded based on a content to be rendered by the browser.

41. The browser as recited in claim 25 wherein the change in the rendering module inventory includes a downloading of a rendering module and wherein the rendering module is stored for downloading on a second server accessible via the Internet.

42. The browser as recited in claim 25 wherein the change in the rendering module inventory includes a downloading of a rendering module and wherein the rendering module is stored for downloading on a second server accessible via the Internet, an Internet address of the second server being stored in a memory of the first server.

43. The browser as recited in claim 25 wherein the change in the rendering module inventory includes a downloading of a rendering module and further comprising storing an Internet address of a location of the rendering module to be downloaded in a memory associated with the browser.

44. The browser as recited in claim 25 wherein the change in the rendering module inventory includes a removal of a rendering module, the removal being performed using a cache architecture-type decision logic.

45. The browser as recited in claim 44 wherein the cache architecture-type decision logic includes a least recently used logic.

46. The browser as recited in claim 25 wherein the browser is an embedded software application.

47. A computer readable medium having stored thereon computer executable process steps operative to perform a method for dynamically adjusting rendering functionality in a browser, the method comprising:
providing a stimulus to the browser; and
reacting to the stimulus using the browser so as to direct a change in a rendering module inventory associated with the browser.

48. The method as recited in claim 47 wherein the stimulus includes at least one of a user interaction, a memory threshold trigger, a freshness logic trigger, a change in IP address, and a change in a browser connection type.

49. The method as recited in claim 47 wherein the stimulus includes a user browsing to a new type of content and further comprising determining at least one or more rendering modules needed for processing the new type of content.

50. The method as recited in claim 49 wherein the processing includes at least one of downloading and displaying the new type of content.

51. The method as recited in claim 51 wherein the change in the rendering module inventory includes at least one of a downloading of a rendering module and a removal of a rendering module.

52. The method as recited in claim 47 wherein the change in the rendering module inventory includes a downloading of the rendering module and wherein the downloading of the rendering module is performed over at least one of a LAN, a dedicated communications link, a telephone line, a satellite link and the Internet.

53. A system for dynamically adjusting rendering functionality in a browser, the system comprising:
a host computer, the browser residing on the host computer;
a first server capable of locating and downloading a rendering module to the browser in response to a request from the browser; and
a communication path connecting the host computer and the server.

54. The system as recited in claim 53 wherein the communication link includes at least one of a LAN, a dedicated communications link, a telephone line, a satellite link and the Internet.

55. The system as recited in claim 53 wherein the rendering module is stored on a second server accessible by the first server over a second communication link.

56. The system as recited in claim 55 wherein the second communication link includes the Internet.

57. The system as recited in claim 53 wherein the request from the browser is provided in response to a stimulus to the browser, the stimulus to the browser including at least one of a user interaction and a change in a browser connection type.

58. The method as recited in claim 57 wherein the user interaction includes a browsing to a new type of content.

59. The method as recited in claim 53 wherein the browser includes a logic unit for providing the request from the browser in response to a stimulus to the browser.

60. The method as recited in claim 53 wherein the browser is an embedded software application.

61. A method for managing a licensing of a plurality of rendering modules, the rendering modules each providing a respective functionality to a browser of a user, the method comprising:
storing the plurality of rendering modules on a server;
downloading to the browser a first of the plurality of rendering modules in response to a request from the browser, the downloaded first rendering module being usable by the browser to render a content; and
determining a licensing fee for the user based on the downloading of the first rendering module or an authorization to download the first rendering module.

62. The method as recited in claim 61 further comprising providing a stimulus to the browser, the request from the browser being provided in response to a stimulus, the stimulus including at least one of a user interaction and a change in a browser connection type.

63. The method as recited in claim 61 wherein the user interaction includes a browsing to a new type of content.

64. The method as recited in claim 61 wherein the stimulus includes a user browsing to a new type of content and further comprising determining at least one or more rendering modules needed for processing the new type of content.

65. The method as recited in claim 64 wherein the processing includes at least one of downloading and displaying the new type of content.

66. The method as recited in claim 61 wherein the browser includes a logic unit for providing the request from the browser in response to a stimulus to the browser.

67. The method as recited in claim 61 wherein the downloading is performed using the server and further comprising using the server to determine the rendering module to be downloaded based on the content to be rendered.

68. The system as recited in claim 61 wherein the downloading is performed via a communication path including at least one of a LAN, a dedicated communication link, a telephone line, a satellite link and the Internet.

69. The method as recited in claim 61 further comprising storing on the server a list of authorized users for each of the plurality of rendering modules.

70. The method as recited in claim 61 wherein the determining the license fee is performed so as to achieve a rendering module availability-based licensing.

71. The method as recited in claim 61 wherein the determining the license fee is performed so as to achieve a per-use licensing.

72. The method as recited in claim 61 wherein the browser is an embedded software application.
